(19) United States
(12) Patent Application Publication
(10) Pub. No.: US 2017/0245473 A1
(43) Pub. Date: Aug. 31, 2017

(54) ANIMAL RESISTANT BIRD FEEDING APPARATUS AND METHOD OF ASSEMBLY

(71) Applicant: Jeffrey L. Hutchens, Belton, MO (US)

(72) Inventor: Jeffrey L. Hutchens, Belton, MO (US)

(21) Appl. No.: 15/433,609

(22) Filed: Feb. 15, 2017

Related U.S. Application Data
(60) Provisional application No. 62/300,140, filed on Feb. 26, 2016.

(51) Int. Cl. A01K 39/01; F16M 13/02; A01K 39/014

(52) U.S. Cl. CPC A01K 39/0113; A01K 39/014; F16M 13/022

(57) ABSTRACT

A bird feeding apparatus including a deck mount, a mounting rod, a feeder tray, and a rotating disk for interfering with animal access to the bird feed placed within the tray. Alternative embodiments may include additional structural elements or hooks for hanging a bird feeder from the apparatus. The rotating disk will cause squirrels or other unwanted animals from accessing bird feed within the feeder tray by spinning, causing gravity to drop the animal. Birds will freely be able to access the feed.

### CROSS REFERENCES TO RELATED APPLICATION

This application claims priority in U.S. Provisional Patent Application No. 62/300,140, filed Feb. 26, 2016, which is incorporated herein by reference.

### BACKGROUND OF THE INVENTION

### 1. Field of the Invention

The present invention relates generally to a bird feeding apparatus and method for use and assembly thereof, and more specifically to an animal resistant bird feeding apparatus including a rotating restricting device.

### 2. Description of the Related Art

People enjoy hanging or otherwise displaying bird feeders for attracting birds to their yards for viewing pleasure and other benefits. However, squirrels and other animals often will steal food from these feeders at any opportunity, preventing the primary purpose of the feeder. Existing devices attempt to prevent intrusion by squirrels and other animals using cages or spinning plates, however these are generally ineffective as squirrels have learned how to adapt to these preventative measures. Other devices make it difficult for even birds to access the feed. What is needed is a device for completely preventing a squirrel or other animal from accessing feed in a bird feeder without preventing the birds from accessing the food themselves.

Heretofore there has not been available a system or method of assembly for an animal resistant bird feeding apparatus with the advantages and features of the present invention.

### BRIEF SUMMARY OF THE INVENTION

The present invention generally provides a bird feeding apparatus including a deck mount, a primary mounting rod, a feeder tray, a secondary mounting rod, and a restricting wheel for interfering with animal access to the bird feed placed within the tray. Alternative embodiments may include additional structural elements or hooks for hanging a bird feeder from the apparatus.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention.

FIG. 2 is a side elevational view thereof.

FIG. 3 is a top plan view thereof.

FIG. 4 is a front elevational view thereof.

FIG. 5 is a rear elevational view thereof.

FIG. 6 is an exploded isometric view thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Animal Resistant Bird Feeder 2

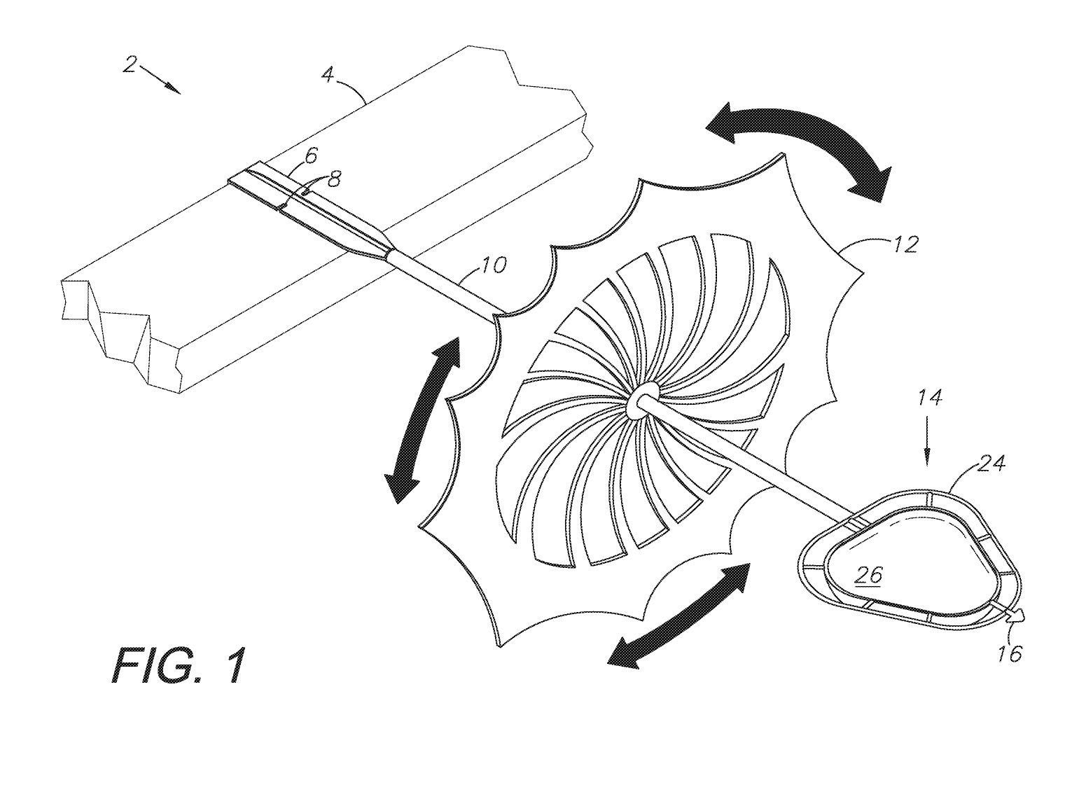

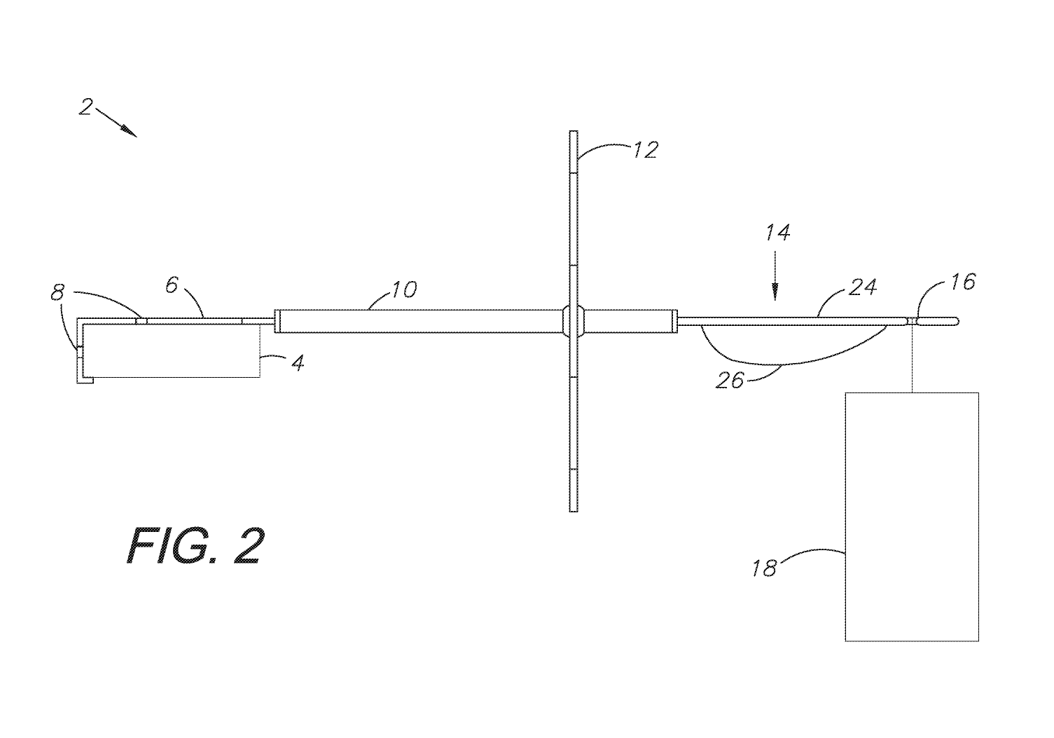

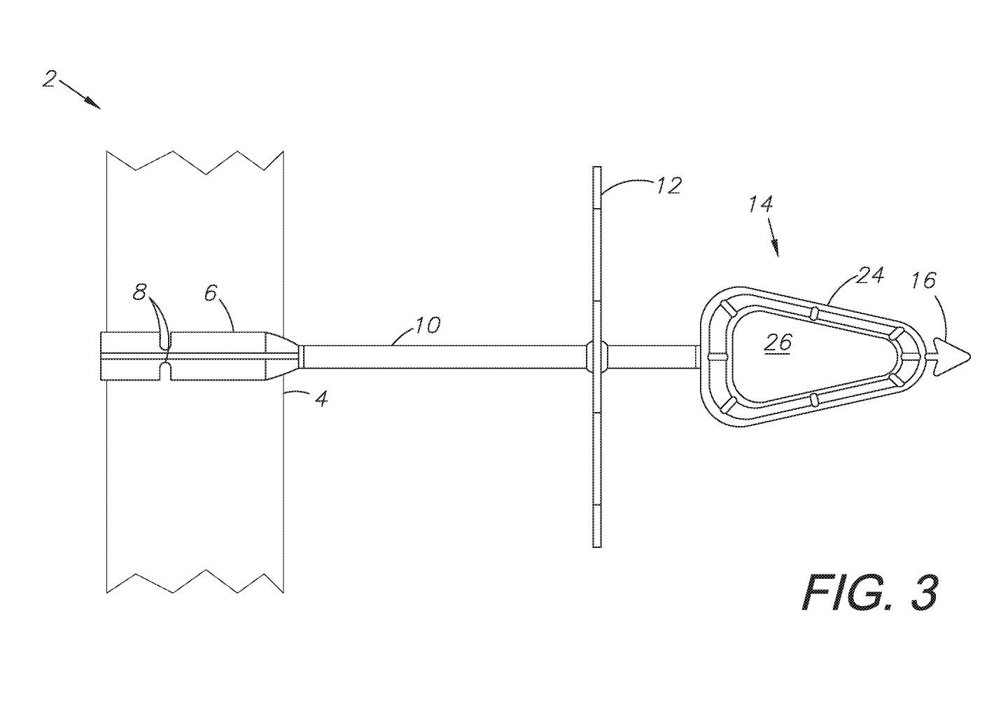

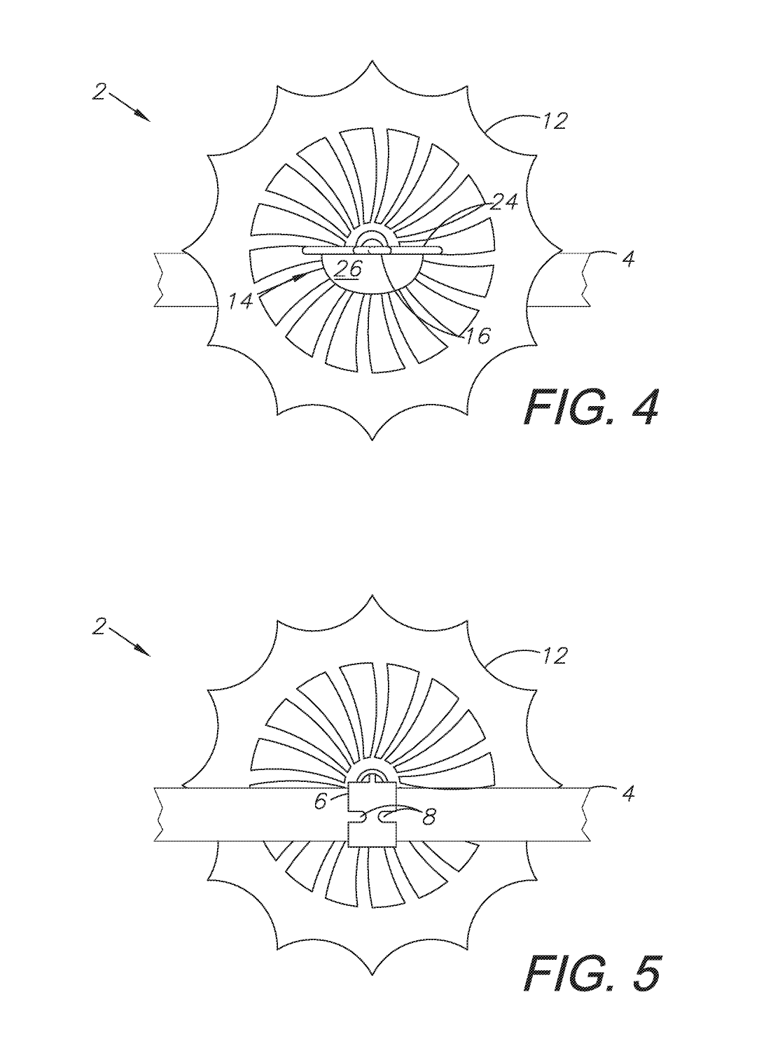

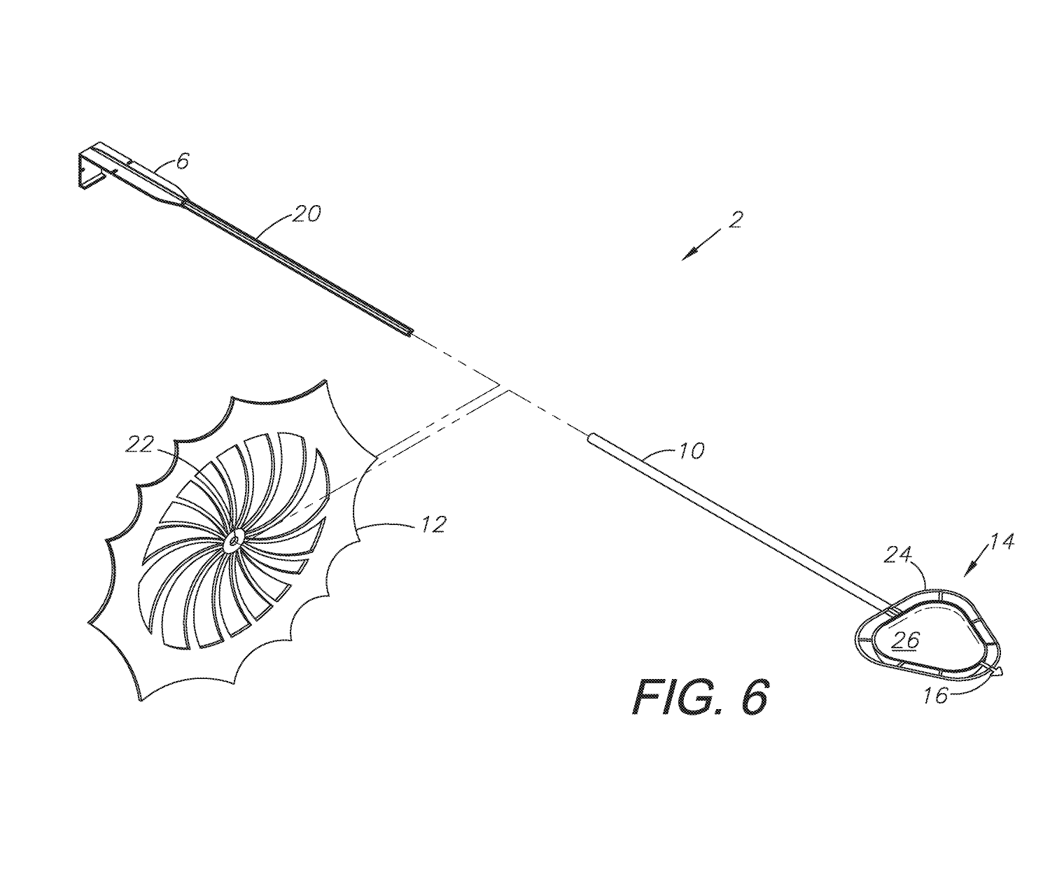

Referring to the figures in more detail, FIG. 1 shows the present invention in an assembled state, whereas FIG. 6 shows the several components which combine to form the invention. The primary component of the animal resistant bird feeder 2 is a vertically oriented rotating disk 12 which restricts access to a bird feed tray 14 located beyond the rotating device. A deck mount 6 allows the device to easily be affixed to a deck 4 or other structural element without the need for tools. Optional support reliefs 8 are provided within the deck mount 6 for screws or nails to secure the deck mount 6 more securely to the deck 4. A primary mounting rod 20 affixes to the deck mount and receives a secondary mounting rod 10 which itself connects to the bird feeder tray 14 and the rotating disk 12.

The feed tray 14 as shown in the figures has an outer rim 24 and an inner tray 26 which, as shown, is slightly curved to fit feed within the tray and prevent it from spilling. A hooked tip 16 allows for another feeder 18 to be hung from the end of the animal resistant bird feeder 2, and this additional feeder 18 would also be protected from interference from animals, such as squirrels, by the rotating disk 12.

The rotating disk 12 as shown in the figures could be a simple disk or include various ornamentation. As shown, the inner spokes prevent the animal from crossing through the disk, whereas the toothed outer edge provides gripping surfaces which catch the animal, causing the disk to spin and drop the animal. Other options would include a simple spoked wheel which provides an outer ring and a cage of spokes. The spokes prevent an animal from accessing the bird feed through the center of the wheel, and the outer ring allows the animal to grip the wheel, which will then spin and cause the animal to fall due to gravity.

FIG. 6 shows how the animal resistant feeder 2 is assembled, where the secondary rod 10 slides through a passage 22 in the rotating disk 12 and onto a primary rod 20 which is affixed to the deck mount 6. As shown, the primary rod 20 has a cross-shaped cross section which fits easily within the hollow secondary rod 10, but which also fits securely against the interior walls of the secondary rod 10.

The deck mount 6 may have a bottom lip for securing against a typical sized deck edge, or other options could be used to secure the deck mount 6 to a deck 4 or other structural element, including screws, nails, tape, clips, or other suitable mounting elements.

Other options include a spoked blade which presents less surface area for the animal to grip around the edges, thereby preventing an animal from using the edge to launch itself over the device. Another design could incorporate a propeller or fan element with multiple fins in place of the rotating disk 12.

In function, the bird feed tray 14 is inaccessible to animals unless the animal traverses the secondary mounting rod 10 from the deck 4 or mounting structure 6. In order to access the feed tray 14, the animal must get past the rotating device 12. However, this is very difficult, bordering on impossible, for an animal, such as a squirrel, because as soon as the animal grips the rotating disk 12, gravity and the weight of the animal's own body forces the disk to spin. This will throw the animal off balance and cause the animal to fall from the device without accessing the bird feed. The rotating device is designed such that an animal cannot easily leap over the rotating device, and any contact with the disk causes the rotating disk 12 to spin freely. This provides security for the bird feed as well as entertainment for viewers watching an animal futilely attempt to access the bird feed and fail each time.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A bird feeder system comprising:
a primary rod having a proximal end and a distal end;
said proximal end of said primary rod affixed to a mounting element configured to engage a fixed structure;
said distal end of said primary rod affixed to a feeder basket configured to store and provide access to bird feed;
a rotating disk interspaced along said primary rod between said proximal end and said distal end; and
wherein said rotating disk is configured to spin when contacted by an animal, thereby preventing the animal from accessing said bird seed.

2. The system of claim 1, further comprising:
wherein said primary rod comprises an inner rod affixed to said mounting element and an outer rod affixed to said feeder basket;
wherein said outer rod is hollow; and
wherein said outer rod slides over said inner rod.

3. The system of claim 1, wherein said rotating disk has an outer edge comprising numerous gripping teeth.

4. The system of claim 1, further comprising:
said feeder basket including a hooked tip;
a second bird feeder configured to be suspended from said hooked tip; and
whereby access to said second bird feeder is restricted by said rotating disk.

5. The system of claim 1, wherein said feeder basket comprises an outer structural rim and an inner basket.
